(19) United States
(12) Patent Application Publication
(10) Pub. No.: US 2020/0123369 A1
(43) Pub. Date: Apr. 23, 2020

(54) Method of Manufacturing Thermoplastic Fluororesin Composite, Method of Manufacturing Electric Wire, and Method of Manufacturing Cable

(71) Applicant: Hitachi Metals, Ltd., Tokyo (JP)

(72) Inventors: Ikuo SEKI, Tokyo (JP); Takashi AOYAMA, Tokyo (JP); Tomiya ABE, Tokyo (JP); Ryutaro KIKUCHI, Tokyo (JP)

(21) Appl. No.: 16/597,294

(22) Filed: Oct. 9, 2019

(30) Foreign Application Priority Data
Oct. 17, 2018 (JP) 2018-196050

(51) Int. Cl. C08L 27/18; C08L 27/16

(52) U.S. Cl. CPC C08L 27/18; C08L 27/16; C08L 2205/02; C08L 2312/00; C08L 2207/04; C08L 2310/00; C08L 2203/202

(57) ABSTRACT

A thermoplastic fluororesin composite that is excellent in mechanical property and heat resistance, and an electric wire and a cable using the thermoplastic fluororesin composite are provided. A method of manufacturing a thermoplastic fluororesin composite includes: a step (double bond forming step) of kneading a mixture containing a fluoro-rubber, a compatibilizer and a crosslinking accelerator to form a double bond in the fluoro-rubber by dehydrofluorination reaction; a step (fluororesin kneading step) of kneading a first product generated in the double bond forming step and a fluororesin; and a step (dynamic crosslinking step) of kneading a second product generated in the fluororesin kneading step and a polyol crosslinker to dynamically crosslink the fluoro-rubber in the second product.

### CROSS-REFERENCE TO RELATED APPLICATION

The present application claims priority from Japanese Patent Application No. 2018-196050 filed on Oct. 17, 2018, the content of which is hereby incorporated by reference into this application.

### TECHNICAL FIELD OF THE INVENTION

The present invention relates to a method of manufacturing a thermoplastic fluororesin composite, a method of manufacturing an electric wire, and a method of manufacturing a cable.

### BACKGROUND OF THE INVENTION

An electric wire has a conductor and an insulating layer as a covering material provided in the periphery of the conductor. A cable includes the electric wire and a sheath (an external covering layer) as a covering material provided in the periphery of the electric wire. The sheath is provided in the periphery of the insulating layer.

The covering material such as the insulating layer of the electric wire and the sheath of the cable is made of an electrical insulating material containing rubber or resin as a main raw material. One example of the electrical insulating material is a thermoplastic elastomer (TPE). Particularly, as a thermoplastic elastomer that is excellent in heat resistance and chemical resistance, for example, a thermoplastic fluororesin composite is cited.

Fluoro-rubber which is one of the thermoplastic fluororesin composites has properties such as excellent heat resistance and chemical resistance, and has thus been used for many purposes in the fields of industries, automobiles, semiconductors, etc. Also, fluororesin which is another one of the thermoplastic fluororesin composites has properties such as excellent slidability, heat resistance, and chemical resistance, and has thus been used for many purposes in the fields of industries, automobiles, semiconductors, etc.

In order to further improve the heat resistance of the fluoro-rubber or to provide flexibility to the fluororesin, a polymer alloy made of the fluoro-rubber and the fluororesin has been studied. However, affinity between the fluoro-rubber and the fluororesin is low. Therefore, only simple melting and kneading (mixing) of the fluoro-rubber and the fluororesin causes a dispersion failure, posing problems such as interlayer delamination and a decrease in strength.

Thus, for example, International Patent Publication No. WO/2006/057332 (Patent Document 1) discloses a technique of obtaining a thermoplastic fluororesin composite by adding a specific compatibilizer as a compatibilizer in addition to the fluoro-rubber and the fluororesin.

### SUMMARY OF THE INVENTION

However, according to studies by the present inventors, it has been found that, when Perfluoroalkoxy Alkane (PFA) is used as the fluororesin configuring the thermoplastic fluororesin composite described above, sufficient mechanical property and heat resistance cannot be obtained in some cases in usage of this material as the covering material such as the external covering layer of the cable or the insulating layer of the electric wire.

Specifically, in the thermoplastic fluororesin composite with the perfluoroalkoxy alkane used as the fluororesin, it has been found that a tensile break strength is less than 10 MPa, and elongation is less than 300%, either. And, in the thermoplastic fluororesin composite with the perfluoroalkoxy alkane used as the fluororesin, it has been found that a continuous use temperature decreases to about 200° C.

The present invention has been made in consideration of such problems, and an object of the present invention is to provide a thermoplastic fluororesin composite that is excellent in mechanical property and heat resistance, and an electric wire and a cable using the thermoplastic fluororesin composite.

The summary of the typical aspects of the inventions disclosed in the present application will be briefly described as follows.

[1] A method of manufacturing a thermoplastic fluororesin composite includes a step (a) of kneading a mixture containing a fluoro-rubber, a compatibilizer, and a crosslinking accelerator to form a double bond in the fluoro-rubber by a dehydrofluorination reaction. And, the method of manufacturing the thermoplastic fluororesin composite includes a step (b) of kneading a first product generated in the step (a) and a fluororesin and a step (c) of kneading a second product generated in the step (b) and a polyol crosslinker to dynamically crosslink the fluoro-rubber in the second product.

[2] In the method of manufacturing thermoplastic fluororesin composite according to [1], the fluororesin is made of perfluoroalkoxy alkane.

[3] In the method of manufacturing the thermoplastic fluororesin composite according to [1], a double bond is formed also in the compatibilizer by the dehydrofluorination reaction in the step (a), and the compatibilizer in the second product is also dynamically crosslinked in the step (c).

[4] In the method of manufacturing the thermoplastic fluororesin composite according to [1], the mixture further contains an acid acceptor.

[5] In the method of manufacturing the thermoplastic fluororesin composite according to [1], the compatibilizer is a tetrafluoroethylene/hexafluoropropylene/vinylidene fluoride terpolymer.

[6] A method of manufacturing an electric wire includes a step (a) of kneading a mixture containing a fluoro-rubber, a compatibilizer, and a crosslinking accelerator to form a double bond in the fluoro-rubber by a dehydrofluorination reaction, a step (b) of kneading a first product generated in the step (a) and a fluororesin, and a step (c) of kneading a second product generated in the step (b) and a polyol crosslinker to dynamically crosslink the fluoro-rubber in the second product. And, the method of manufacturing the electric wire includes a step (d) of extruding a thermoplastic fluororesin composite generated in the step (c) so as to cover the conductor to form an insulating layer.

[7] A method of manufacturing a cable includes a step (a) of kneading a mixture containing a fluoro-rubber, a compatibilizer, and a crosslinking accelerator to form a double bond in the fluoro-rubber by a dehydrofluorination reaction, a step (b) of kneading a first product generated in the step (a) and a fluororesin, and a step (c) of kneading a second product generated in the step (b) and a polyol crosslinker to dynamically crosslink the fluoro-rubber in the second product. And, the method of manufacturing the cable includes a step (d) of covering an electric wire with a filler, and then, extruding the thermoplastic fluororesin composite generated in the step (c) so as to cover the filler to form a sheath.

According to the present invention, a thermoplastic fluororesin composite that is excellent in mechanical property and heat resistance, and an electric wire and a cable using the thermoplastic fluororesin composite can be provided.

### BRIEF DESCRIPTIONS OF THE DRAWINGS

FIG. 1 is a flow showing steps of manufacturing a thermoplastic fluororesin composite of one embodiment;

FIG. 2 is a horizontal cross-sectional view showing a structure of an electric wire of one embodiment;

FIG. 3 is a horizontal cross-sectional view showing a structure of a cable of one embodiment;

FIGS. 4A to 4F are scanning electron microscopical images of horizontal cross sections of extruded capillary strand samples of practical examples 1 to 6; and

FIG. 5 is a scanning electron microscopical image of a horizontal cross section of an extruded capillary strand sample of a practical example 7.

### DESCRIPTIONS OF THE PREFERRED EMBODIMENTS

(Studied Content)

Prior to description of embodiments, contents studied by the present inventors are described first.

Perfluoroalkoxy Alkane (PFA) which is one of the fluororesins is a fluororesin which has a high melting point and is melt-fabricable as similar to other fluororesins. Thus, in a thermoplastic fluororesin composite made of a fluoro-rubber (A), a fluororesin (B) and a compatibilizer (C), if the perfluoroalkoxy alkane is used as the fluororesin, it is expected to form a thermoplastic fluororesin composite that is excellent in mechanical property such as tensile property and heat resistance.

However, as described above, in the thermoplastic fluororesin composite with the perfluoroalkoxy alkane used as the fluororesin, the present inventors have found that the sufficient tensile property and heat resistance cannot be obtained in some cases. In analysis of the thermoplastic fluororesin composite being incapable of obtaining the sufficient tensile property and heat resistance, it has been found that this thermoplastic fluororesin composite has a phase structure in which the fluoro-rubber (A) is a continuous phase (sea phase, matrix) while the fluororesin (B) is a dispersion phase (island phase, domain) or has a phase structure in which both the fluoro-rubber (A) and the fluororesin (B) are the continuous phase (sea phase).

Therefore, in order to obtain the sufficient tensile property and heat resistance for use as the covering material such as the outer covering layer of the cable or the insulating layer of the electric wire, it is required in the thermoplastic fluororesin composite as different from the case described above to form a phase structure such as so-called a sea-island structure in which the fluoro-rubber (A) is the dispersion phase (island phase) while the fluororesin (B) is the continuous phase (sea phase). This is because elasticity is obtained for the entire composite at a room temperature since the fluoro-rubber (A) which is an elastic body exists as the dispersion phase (island phase) in the composite. And, the continuous phase (sea phase) flows at a high temperature to allow plastic deformation since the thermoplastic fluororesin (B) exists as the continuous phase (sea phase) in the composite.

As a result, the thermoplastic fluororesin composite has the sufficient tensile property as the covering material for the cable and the electric wire, and can easily configure the cable or the electric wire by using a fabrication machine that is similar to that for the thermoplastic material.

Here, in order to obtain the above-described sea-island structure, that is, the phase structure in which the fluoro-rubber (A) is the dispersion phase (island phase) while the fluororesin (B) is the continuous phase (sea phase), it is necessary to dynamically crosslink (vulcanize) fluoro-rubbers in the thermoplastic fluororesin composite. The dynamic crosslinking is a crosslinking method of causing a crosslinking reaction while materials are kneaded. By this dynamic crosslinking, the fluoro-rubbers are crosslinked to be cured, and the crosslinked fluoro-rubbers are completely and uniformly dispersed as the dispersion phase (island phase) in the continuous phase (sea phase) of the fluororesin.

In a general method (hereinafter, referred to as a study example 1) of manufacturing the thermoplastic fluororesin composite, the fluoro-rubber (non-crosslinked fluoro-rubber) (A), the fluororesin (B), the compatibilizer (C), a polyol crosslinker (D), a crosslinking accelerator (E), a crosslinking accelerator aid (acid acceptor) (F), etc., are kneaded by a pressure kneader, etc. In this manner, the crosslinking of the fluoro-rubbers (A) proceeds at the time of kneading, so that a target thermoplastic fluororesin composite can be obtained.

Here, problems in the study example 1 that have been found by the present inventors will be described. As described above, the dynamic crosslinking is performed with the materials being kneaded, and is thus needed to be performed at a temperature that is at least equal to or higher than the melting point of each material. Of the materials of the thermoplastic fluororesin composite, the fluororesin has the highest melting point. As described later, a substituent of a generally used perfluoroalkoxy alkane is a perfluoroethyl group, and the perfluoroalkoxy alkane has a melting point of 305° C. Here, when the temperature at which the dynamic crosslinking is to be performed is nearly equal to the melting point of the fluororesin, the kneading with each material does not proceed in some cases. Thus, in consideration of sufficient kneading and sufficient reaction promotion, the temperature suitable for the dynamic crosslinking is 20 to 40° C. higher than this melting point of the fluororesin (that is, the temperature is 325° C. to 345° C.). However, in general, the temperature at which thermal decomposition of the fluoro-rubber starts is 310° C. to 320° C. Thus, the dynamic crosslinking performed at 335° C. by the manufacturing method of the study example 1 has caused a problem so that the crosslinking reaction severely proceeds to thermally decompose the fluoro-rubber, which results in easy occurrence of particles at the time of the extrusion. In study on a reason why the fluoro-rubber is thermally decomposed, it has been found that the dehydrofluorination reaction of the fluoro-rubber using the crosslinking accelerator (E) explosively occurs under a condition of a high temperature that is equal to or higher than 320° C., which results in cutting off of the binding of the fluoro-rubber to decrease a crosslink density.

Accordingly, the present inventors have found that, if the perfluoroalkoxy alkane having a melting point equal to or lower than 290° C. is used as the fluororesin (B), a target thermoplastic fluororesin composite can be obtained in the manufacturing method of the study example 1. Specifically, when the fluororesin (B) having a melting point of, for example, 285° C. is used as the method of manufacturing the thermoplastic fluororesin composite in the study example 1, the thermal decomposition of the fluoro-rubber (A) can be suppressed by the kneading at a temperature of 290° C. to 310° C. However, as described above, the study example 1 has a problem in which the perfluoroalkoxy alkane with the fluororesin (B) having the melting point equal to or higher than about 300° C. cannot be used.

Thus, the present inventors have improved the manufacturing method of the study example 1, and found a method (hereinafter, referred to as a study example 2) of manufacturing the thermoplastic fluororesin composite using the perfluoroalkoxy alkane with the fluororesin (B) having the melting point equal to or higher than about 300° C.

Specifically, a method of manufacturing a thermoplastic fluororesin composite of the study example 2 includes a step (a) of kneading a mixture containing the fluoro-rubber (A), a first fluororesin (B′), the compatibilizer (C), the polyol crosslinker (D), the crosslinking accelerator (E) and the crosslinking accelerator aid (acid acceptor) (F) for dynamic crosslinking and a step (b) of mixing the product in the step (a) and a second fluororesin (B″) and extruding these materials so as to form a tube shape. Here, the first fluororesin (B′) is made of a fluororesin having a melting point that is equal to or lower than 275° C. The second fluororesin (B″) is made of a fluororesin having a melting point that is equal to or higher than 300° C.

In this manner, in the study example 2, (a pellet of) a product having a higher blend ratio of the fluoro-rubber (A) than that of the thermoplastic fluororesin composite as the target product is previously generated in the step (a), and then, the second fluororesin (B″) is mixed (dry-blended) in the step (b). It has been found that the thermal decomposition of the fluoro-rubber (A) can be minimized by these steps, so that a thermoplastic fluororesin composite in which the crosslinked fluoro-rubber (A) is the dispersion phase (island phase) while the first fluororesin (B′) and the second fluororesin (B″) are the continuous phase (sea phase) can be generated.

Particularly, in the study example 2, it has been found that, even if a normal fluororesin (melting point: 305° C.) or a fluororesin having a higher melting point (melting point: 313° C.) is used as the second fluororesin (B″), a thermoplastic fluororesin composite in which the crosslinked fluoro-rubber (A) is the dispersion phase (island phase) while the first fluororesin (B′) and the second fluororesin (B″) are the continuous phase (sea phase) can be generated.

Here, problems of the study example 2 that have been found by the present inventors are described. When the thermoplastic fluororesin composite is used as, for example, a covering material for an electric wire or a cable, it is particularly necessary to enhance flexibility and elasticity of the thermoplastic fluororesin composite.

In the study example 2, the fluoro-rubber (A) has higher flexibility and elasticity than the fluororesin (B). Therefore, in order to enhance the flexibility of the thermoplastic fluororesin composite, it is desirable to make a mass ratio of the fluoro-rubber (A) with respect to the fluororesin (B) in the thermoplastic fluororesin composite as high as possible.

However, according to studies by the present inventors, in the study example 2, it has been found that, if the mass ratio of the fluoro-rubber (A) with respect to the fluororesin (B) in the thermoplastic fluororesin composite is high, the thermoplastic fluororesin composite in which the crosslinked fluoro-rubber (A) is the dispersion phase (island phase) while the fluororesin (B) is the continuous phase (sea phase) cannot be generated. A reason for this can be thought as follows. In the study example 2, the fluoro-rubber (A) and the first fluororesin (B′) are kneaded, the fluoro-rubber (A) is crosslinked, and then, the second fluororesin (B″) is added and kneaded. Thus, if the high mass ratio of the fluoro-rubber (A) with respect to the fluororesin (B) is attempted, the mass ratio of the fluoro-rubber (A) with respect to the first fluororesin (B′) in the product in the step (a) is too high. As a result, the product in the step (a) has a phase structure in which the fluoro-rubber (A) is the continuous phase (sea phase) while the first fluororesin (B′) is the dispersion phase (island phase). Here, it can be thought that the phase structure cannot be reversed even if the second fluororesin (B″) is also added and kneaded to and with the product in the step (a) later in the step (b) because a network of the crosslinked fluoro-rubber (A) is rigidly formed in the product in the step (a). From this, in the manufacturing method of the study example 2, it has been found that the enhancement of the flexibility and the heat resistance of the thermoplastic fluororesin composite is difficult.

Note that it can be also thought that the fluoro-rubber (A) is added in the step (b) or a later step. However, this case has a problem in which the polyol crosslinker (D) and the crosslinking accelerator (E) that are necessary for the dynamic crosslinking have been completely consumed in the step (a), and thus, the added fluoro-rubber (A) cannot be dynamically crosslinked. If the polyol crosslinker (D) and the crosslinking accelerator (E) are added in addition to the fluoro-rubber (A), this is equivalent to one more execution of the crosslinking step of the manufacturing method of the study example 1, and has the same problem as the thermal decomposition of the fluoro-rubber (A) and increases the number of steps to increase the manufacturing cost.

Thus, in the method of manufacturing the thermoplastic fluororesin composite using the perfluoroalkoxy alkane as the fluororesin, it is desirable to contrive its steps to allow formation of a thermoplastic fluororesin composite that is excellent in the mechanical property and the heat resistance.

### Embodiments

(1) Thermoplastic Fluororesin Composite

A thermoplastic fluororesin composite according to one embodiment of the present invention contains a fluoro-rubber (A), a fluororesin (B), and a compatibilizer (C). In the thermoplastic fluororesin composite, the fluoro-rubber (A) is crosslinked in a dynamic crosslinking from. The fluororesin (B) is perfluoroalkoxy alkane. The compatibilizer (C) is a tetrafluoroethylene/hexafluoropropylene/vinylidene fluoride terpolymer. In the terpolymer, a molar ratio of “tetrafluoroethylene unit:hexafluoropropylene unit:vinylidene fluoride unit” is “30 to 70:15 to 40:10 to 50”. As a result, a specific gravity of the compatibilizer (C) is equal to or larger than about 1.90. The fluoro-rubber (A) and the fluororesin (B) have a mass ratio (%) of “20 to 60:80 to 40”. A blend amount of the compatibilizer (C) is 1 to 30 parts by weight per a total of 100 parts by weight of the fluoro-rubber (A) and the fluororesin (B).

While the fluororesin (B) may be a single fluororesin, two or more types of fluororesin may be mixed as described in a later embodiment.

In the mass ratio between the fluoro-rubber (A) and the fluororesin (B), if the mass ratio of the fluororesin (B) is smaller than a 40 mass ratio (%), in the generated thermoplastic fluororesin composite, both the crosslinked fluoro-rubber (A) and the fluororesin (B) become the continuous phase (sea phase), or the crosslinked fluoro-rubber (A) becomes the continuous phase (sea phase) while the fluororesin (B) becomes the dispersion phase (island phase). As a result, in the generated thermoplastic fluororesin composite, appearance (extruded appearance) deteriorates, and the tensile strength and the elongation of this thermoplastic fluororesin composite greatly decrease. Also, the continuous use temperature of this thermoplastic fluororesin composite decreases to about 200° C. Here, the continuous use temperature is a temperature at which, for example, an absolute value of the elongation decreases to 50% in exposure to ambient air for forty thousand hours under a constant temperature.

Also, in the mass ratio between the fluoro-rubber (A) and the fluororesin (B), if the mass ratio of the fluororesin (B) is larger than an 80 mass ratio (%), that is, if the mass ratio of the fluoro-rubber (A) is smaller than a 20 mass ratio (%), the flexibility (bendability) of the generated thermoplastic fluororesin composite significantly decreases.

From the above, in overall consideration of the tensile property, the heat resistance, the flexibility, etc., the mass ratio (%) between the fluoro-rubber (A) and the fluororesin (B) is preferably “20 to 60:80 to 40”, and more preferably “30 to 50:70 to 50”.

If the blend amount of the compatibilizer (C) is smaller than 1 part by weight per the total of 100 parts by weight of the fluoro-rubber (A) and the fluororesin (B), a dispersion diameter of the crosslinked fluoro-rubber (A) becomes large, and the extruded appearance of the generated thermoplastic fluororesin composite deteriorates. The compatibilizer (C) of the present embodiment is a tetrafluoroethylene/hexafluoropropylene/vinylidene fluoride terpolymer having a small molar ratio of the vinylidene fluoride unit forming a double bond (that is a crosslinkable unit) by dehydrofluorination. Thus, if the blend amount of the compatibilizer (C) is larger than 30 parts by weight per the total of 100 parts by weight of the fluoro-rubber (A) and the fluororesin (B), there is a problem in which a crosslink density that is appeared in the thermoplastic fluororesin composite decreases so that the fluoro-rubbers (A) that have been crosslinked at the time of extrusion tend to coagulate to generate particles. Thus, the blend amount of the compatibilizer (C) is preferably 1 to 30 parts by weight per the total of 100 parts by weight of the fluoro-rubber (A) and the fluororesin (B), and more preferably 2 to 20 parts by weight.

Also, in the present embodiment, in the generated thermoplastic fluororesin composite, an average grain diameter of the crosslinked fluoro-rubber (A) configuring the dispersion phase (island phase) is preferably equal to or smaller than 10 μm, and more preferably equal to or smaller than 5 μm. When the average grain diameter of the crosslinked fluoro-rubber (A) is equal to or smaller than 10 μm, the draw-down capability, the tensile property, the heat resistance, etc., of the thermoplastic fluororesin composite can be made more excellent.

<Fluoro-Rubber>

The fluoro-rubber (A) of the present embodiment is a vinylidene-fluoride-based fluoro-rubber (FKM). More specifically, the fluoro-rubber (A) is preferably a Hexafluoropropylene (HFP)/Vinylidene Fluoride (VdF) bipolymer (such as Viton A (registered trademark) produced by DuPont de Nemours, Inc., or DAI-EL G-701 (registered trademark) produced by DAIKIN INDUSTRIES, LTD). Alternatively, the fluoro-rubber may be a Tetrafluoroethylene (THF)/Hexafluoropropylene (HFP)/Vinylidene Fluoride (VdF) terpolymer (such as Viton B (registered trademark) produced by DuPont de Nemours, Inc., or DAI-EL G-551 (registered trademark) produced by DAIKIN INDUSTRIES, LTD). The terpolymer classified as the fluoro-rubber (A) has a molar ratio (%) of “the tetrafluoroethylene unit:the hexafluoropropylene unit:the vinylidene fluoride unit” is “0.1 to 30:15 to 60:40 to 80” (specific gravity of 1.85 to 1.88). Among these ratios, a molar ratio of the vinylidene fluoride unit having properties as the fluoro-rubber that is equal to or larger than 50% is preferable.

<Fluororesin>

The fluororesin (B) of the present embodiment contains the perfluoroalkoxy alkane (see a first chemical formula).

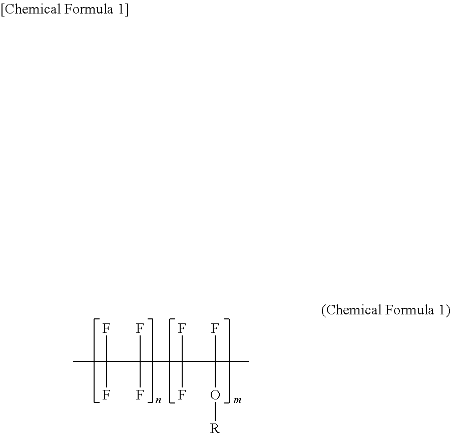

The perfluoroalkoxy alkane is a copolymer of perfluoroalkylvinyl ether and tetrafluoroethylene. Here, the perfluoroalkyl group is obtained by substituting all hydrogens (H) of the alkyl group to fluorines (F).

More specifically, as the fluororesin (B), for example, perfluoroalkoxy alkane (melting point: 305° C.) in which the alkyl group (“R” in the chemical formula 1) is the perfluoroethyl group, more specially a copolymer of trifluoro (trifluoroethoxy) ethylene and tetrafluoroethylene can be used.

Also, as the fluororesin (B), for example, perfluoroalkoxy alkane (melting point: 285° C.) in which the alkyl group (“R” in the chemical formula 1) includes both of the perfluoromethyl group and the perfluoropropyl group can be used. Specifically, as the fluororesin (B), a copolymer of trifluoro (trifluoromethoxy) ethylene, 1,1,1,2,2,3,3-heptafluoro-3-[(trifluoroethenyl) oxy]propane and tetrafluoroethylene can be used.

As the fluororesin (B), for example, perfluoroalkoxy alkane (melting point: 270° C.) in which the alkyl group (“R” in the chemical formula 1) is a perfluoromethyl group, more specifically a copolymer of trifluoro (trifluoromethoxy) ethylene and tetrafluoroethylene can be used.

<Compatibilizer>

The compatibilizer (C) of the present embodiment is a Tetrafluoroethylene (THF)/Hexafluoropropylene (HFP)/Vinylidene Fluoride (VdF) terpolymer. This terpolymer is preferable to be a terpolymer (specific gravity that is equal to or larger than about 1.90) having the molar ratio (%) of “tetrafluoroethylene unit:hexafluoropropylene unit:vinylidene fluoride unit” that is “30 to 70:15 to 40:10 to 50” (such as THV fluoroplastic (registered trademark) produced by Sumitomo 3M Limited).

The terpolymer is common with the fluororesin (B) in that tetrafluoroethylene is contained as a monomer unit. Also, since the terpolymer contains vinylidene fluoride as a monomer unit, its polarity is close to that of the fluoro-rubber (A). Thus, in the terpolymer, if the molar ratio of the tetrafluoroethylene unit becomes equal to or larger than 30% and the molar ratio of the vinylidene fluoride unit becomes equal to or smaller than 50%, this terpolymer has an intermediate property between those of the fluoro-rubber and the fluororesin. Since this terpolymer has a property of fluororesin, the terpolymer acts as the compatibilizer (C) for the fluoro-rubber (A) and the fluororesin (B). And, since this terpolymer has crystals, the thermoplastic fluororesin composite can be pelletized as seen in a crosslinking fluoro-rubber masterbatch described later by using this terpolymer as the compatibilizer (C).

<Crosslinker>

As the crosslinker of the present embodiment, the polyol crosslinker (D) is used. Details of the polyol crosslinking will be described later. As the polyol crosslinker (D), for example, bisphenol AF, bisphenol A, p,p′-biphenol, 4,4′-dihydroxy diphenylmethane, hydroquinone, dihydroxy benzophenone, and alkali metal salt of them, etc., are cited. In the present embodiment, in view of the heat resistance, it is preferable to use aromatic-based polyol, and more particularly the bisphenol AF.

In a polyol crosslinking reaction, it is preferable to use not only the crosslinker but also a crosslinking accelerator described later. This is because the formation of the double bond is necessary in the fluoro-rubber (A) before the polyol crosslinking reaction in order to efficiently make the polyol crosslinking reaction as described later, and besides, it is necessary for the double bonding to catalyze the dehydrofluorination reaction of the fluoro-rubber (A) by using the crosslinking accelerator.

Furthermore, in addition to the crosslinking accelerator, it is more preferable to use a crosslinking accelerator aid together. This is because it is necessary to neutralize the hydrogen fluoride by using an acid acceptor serving as the crosslinking accelerator aid since the hydrogen fluoride is generated in the dehydrofluorination reaction.

Amounts of the crosslinker and the crosslinking accelerator (aid) are not particularly limited, and the amounts can be appropriately determined in accordance with an intended crosslinking degree, a type of the crosslinking accelerator (aid), etc. However, if the amounts of the crosslinker and the crosslinking accelerator (aid) are too small, there are problems in which the crosslink density decreases to make it difficult for the fluororesin (B) to form the continuous phase (sea phase), and besides, in which the dispersion phases (island phases) made of the fluoro-rubbers (A) that have been crosslinked at the time of extrusion coagulate to cause the particles. On the other hand, if the amounts of the crosslinker and the crosslinking accelerator (aid) are too large, there is a problem in which the crosslink density of the fluoro-rubber (A) increases, which results in decrease in the draw-down capability at the time of extrusion since a viscosity of the generated thermoplastic fluororesin composite is too high. Thus, it is preferable to add 1 to 10 parts by weight of each of the crosslinker, the crosslinking accelerator, and the crosslinking accelerator aid per 100 parts by weight of the fluoro-rubber (A).

<Crosslinking Accelerator>

As described above, the crosslinking accelerator of the present embodiment is a dehydrofluorination catalyst which catalyzes the dehydrofluorination reaction of the fluoro-rubber (A), and is preferably, for example, onium salt (ammonium salt or phosphonium salt), amine, etc. Specifically, as the crosslinking accelerator, it is more preferable to use an organic phosphonium salt such as Benzyl triphenyl phosphonium chloride (BTPPC), quaternary ammonium salt such as tetrabutyl ammonium=chloride, 1,8-diazabicyclo[5.4.0]-7-undecene, hexamethylene tetramine, etc.

<Crosslinking Accelerator Aid>

As described above, the crosslinking accelerator aid of the present embodiment is an acid acceptor which neutralizes the hydrogen fluoride generated during the dehydrofluorination reaction, and is preferably, for example, a metal oxide such as magnesium oxide (MgO), calcium hydroxide (Ca(OH)₂), calcium oxide (CaO), lead oxide (PbO), etc. Alternatively, a plurality of these acid acceptors may be used in combination. Since a compression set of the thermoplastic fluororesin composite obtained after the polyol crosslinking reaction is favorable, it is more preferable to use a high-active magnesium oxide as the acid acceptor. Also, when the onium salt is used as the dehydrofluorination catalyst in dehydrofluorination reaction, it is also preferable to use the calcium hydroxide as the acid acceptor since it acts as its co-catalyst.

When the magnesium oxide or the calcium hydroxide is used as the crosslinking accelerator aid, it is preferable to use 1 to 10 parts by weight, more particularly 2 to 8 parts by weight, of the magnesium oxide or the calcium hydroxide per 100 parts by weight of the fluoro-rubber (A).

<Dynamic Crosslinking>

As described above, the dynamic crosslinking is a crosslinking method of performing a crosslinking reaction while raw materials are kneaded. Specifically, in the present embodiment, the crosslinking reaction is caused to proceed while a mixture of the fluoro-rubber (A), the fluororesin (B), and the compatibilizer (C) is kneaded. In this manner, the fluoro-rubber (A) is crosslinked in the thermoplastic fluororesin composite that is the product.

In the thermoplastic fluororesin composite, if the fluoro-rubber (A) is crosslinked, the dispersion diameter of the fluoro-rubber (A) decreases, and the fluororesin (B) can easily form the continuous phase. Thus, such a thermoplastic fluororesin composite has the favorable tensile property and heat resistance since it is difficult to cause the particles resulting from the coagulation of the fluoro-rubber (A) at the time of extrusion.

In the present embodiment, the polyol crosslinking reaction is used as the dynamic crosslinking method. The polyol crosslinking reaction is a reaction for crosslinking a portion inside the fluoro-rubber molecular chain or a portion between the fluoro-rubber molecular chains by (i) forming the double bond by eliminating the hydrogen fluoride (the dehydrofluorination reaction) from the fluoro-rubber molecular chain while using the onium salt (such as ammonium salt or phosphonium salt) as the catalyst and (ii) adding a bisphenol compound to two or more double bonds formed in the fluoro-rubber molecular chain. In this method, by adding the calcium hydroxide which is the co-catalyst for the onium salt, the calcium hydroxide acts as the catalyst for the dehydrofluorination reaction.

As the dynamic crosslinking method, a method other than the polyol crosslinking reaction can be also cited. However, for a polyamine crosslinker and a peroxide crosslinker of the generally-used crosslinkers, it is necessary to perform the reaction at a temperature that is lower than the melting point of the fluororesin (B), and thus, the mixture of the fluoro-rubber (A), the fluororesin (B), and the compatibilizer (C) cannot be kneaded, and these crosslinkers cannot be applied to the present invention. Also, electron beam crosslinking using electron beams originally cannot be used under the kneading, and thus, cannot be applied to the present invention.

Also, according to the studies made by the present inventors, by the polyol crosslinking reaction, not only the fluoro-rubber (A) but also the compatibilizer (C) can be crosslinked. That is, in the thermoplastic fluororesin composite of the present embodiment, the compatibilizer (C) may also be partially crosslinked. In this manner, the occurrence of the particles when the thermoplastic fluororesin composite is extruded can be suppressed, and the tensile property and the heat resistance of the thermoplastic fluororesin composite can be further favorable.

<Method of Manufacturing Thermoplastic Fluororesin Composite>

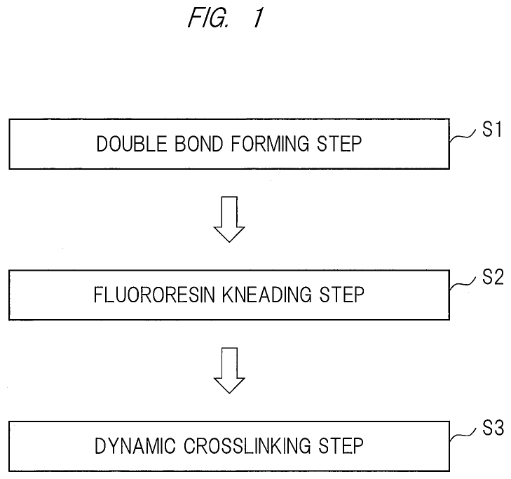

FIG. 1 is a flow showing steps of manufacturing the thermoplastic fluororesin composite of the present embodiment. As shown in FIG. 1, the method of manufacturing the thermoplastic fluororesin composite of the present embodiment includes a step (S1) (double bond forming step) of forming the double bonds in the fluoro-rubber (A) by kneading the mixture containing the fluoro-rubber (A), the compatibilizer (C), the crosslinking accelerator (E), and the crosslinking accelerator aid (acid acceptor) (F) and performing the dehydrofluorination reaction. And, the method of manufacturing the thermoplastic fluororesin composite includes a step (S2) (fluororesin kneading step) of kneading a product (first product) in the step (S1) and the fluororesin (B). And, the method of manufacturing the thermoplastic fluororesin composite includes a step (S3) (dynamic crosslinking step) of kneading a product (second product) in the step (S2) and the polyol crosslinker (D) and dynamically crosslinking the fluoro-rubber (A) in the product in the step (S2).

Also, the double bonds are also formed in the compatibilizer (C) by the dehydrofluorination reaction in the step (S1), and the compatibilizer (C) in the product in the step (S2) is also dynamically crosslinked in the step (S3).

A temperature in the step (S1) is equal to or higher than a temperature at which the dehydrofluorination reaction proceeds, and is lower than a temperature at which the fluoro-rubber (A) is thermally decomposed. A temperature in the step (S2) is 15 to 40° C. higher than the melting point of the fluororesin (B). As a result, the temperature in the step (S2) is higher than the temperature in the step (S1).

In the step (S1), the dehydrofluorination reaction of the fluoro-rubber (A) and the compatibilizer (C) is accelerated to proceed by the crosslinking accelerator (E), and the double bonds are formed in the fluoro-rubber (A) and the compatibilizer (C). In the step (S1), since the hydrogen fluoride generated by the dehydrofluorination reaction is neutralized and removed by the crosslinking accelerator aid (acid acceptor) (F), the crosslinking accelerator aid (F) also accelerates the dehydrofluorination reaction. Thus, in the step (S1), although it is not necessary to add the crosslinking accelerator aid (acid acceptor) (F), it is preferable to add the crosslinking accelerator aid (acid acceptor) (F).

In the step (S2), the fluoro-rubber (A) and the compatibilizer (C) with the double bonds formed are kneaded with the fluororesin (B), and the fluoro-rubber (A) and the compatibilizer (C) with the double bonds formed are dispersed in the fluororesin (B). Also, since the temperature in the step (S2) is higher than the temperature in the step (S1), if there is the crosslinking accelerator (E) not reacting in the step (S1), the crosslinking accelerator (E) is completely consumed in the step (S2).

In the step (S3), the crosslinking reaction of the fluoro-rubber (A) and the compatibilizer (C) with the double bonds formed proceeds by using the polyol crosslinker (D).

By the step (S1) and the step (S2) described above, the thermoplastic fluororesin composite in which the crosslinked fluoro-rubber (A) is the dispersion phase (island phase) while the fluororesin (B) is the continuous phase (sea phase) can be generated.

As a kneading apparatus for manufacturing the thermoplastic fluororesin composite of the present embodiment, a publicly-known kneading apparatus that is, for example, a batch-type kneader such as a Banbury mixer or a pressure kneader, or a continuous-type kneader such as a twin-screw extruder can be adopted.

As a specific example of the method of manufacturing the thermoplastic fluororesin composite of the present embodiment, a case of using the fluororesin (B) having a melting point of 305° C. will be described for an example. First, in the step (S1), the fluoro-rubber (non-crosslinked fluoro-rubber) (A), the compatibilizer (C), the crosslinking accelerator (E), the crosslinking accelerator aid (acid acceptor) (F), a colorant, etc., are kneaded by a pressure kneader at a temperature of 200° C. to 240° C. for three to five minutes to generate the pellet (hereinafter referred to as a fluoro-rubber masterbatch).

Next, in the step (S2), the fluoro-rubber masterbatch generated in the step (S1) and the fluororesin (B) are kneaded by a twin-screw extruder at a temperature of 320° C. to 345° C. for three to five minutes until a kneaded product becomes substantially uniform.

Next, in the step (S3), the kneaded product (product) generated in the step (S2) and the polyol crosslinker (D) are kneaded for three to five minutes. In this manner, a target thermoplastic fluororesin composite can be obtained.

For example, in a case of a continuous-type kneader such as a twin-screw extruder having a first loading port and a second loading port that are away from each other along an extruding direction, the fluoro-rubber masterbatch and the fluororesin (B) are loaded from the first loading port, and the polyol crosslinker (D) is loaded from the second loading port, so that the step (S2) and the step (S3) can be continuously performed in one kneading apparatus.

<Features and Effects of Thermoplastic Fluororesin Composite>

One of features of the method of manufacturing the thermoplastic fluororesin composite according to one embodiment of the present invention is the formation of the double bonds in the fluoro-rubber (A) and the compatibilizer (C) in a state without the fluororesin (B) and the polyol crosslinker (D) in the step (S1). Then, in the step (S2), the fluoro-rubber (A) and the compatibilizer (C) with the double bonds formed are sufficiently kneaded with the fluororesin (B) in a state without the polyol crosslinker (D). Then, in the step (S3), the crosslinking reaction is caused to proceed after the sufficient kneading of the fluoro-rubber (A), the fluororesin (B), and the compatibilizer (C).

In the present embodiment, by adopting these steps in the method of manufacturing the thermoplastic fluororesin composite using the perfluoroalkoxy alkane as the fluororesin, the thermoplastic fluororesin composite that is excellent in the flexibility and the heat resistance can be generated. A reason for this will be specifically described below.

As described above, the polyol crosslinking reaction which is one of the dynamic crosslinking methods includes two steps of (i) the double bond forming step and (ii) the crosslinking step. Specifically, the method includes the step (i) of forming the double bonds by eliminating the hydrogen fluoride (the dehydrofluorination reaction) from the fluoro-rubber molecular chain and the step (ii) of crosslinking the portion inside the fluoro-rubber molecular chain or the portion between the fluoro-rubber molecular chains by adding the bisphenol compound to the two or more double bonds formed in the fluoro-rubber molecular chain.

In the present embodiment, the polyol crosslinking reaction is divided into the step (S1) corresponding to the double bond forming step (i) and the step (S3) corresponding to the crosslinking step (ii). And, in the step (S1), the fluororesin (B) and the polyol crosslinker (D) are not added. In this manner, as different from the study example 1, it is unnecessary to increase the reaction temperature in the step (S1) in accordance with the melting point of the fluororesin (B).

Specifically, when the perfluoroalkoxy alkane having a melting point that is equal to or higher than 300° C. is used as the fluororesin (B) in the study example 1, it is necessary in the study example 1 to set the temperature in the step (i) to 325° C. to 345° C. in consideration of the sufficient kneading, etc. However, as described above, the dehydrofluorination reaction of the fluoro-rubber (A) using the crosslinking accelerator (E) explosively occurs under the condition of the high temperature that is equal to or higher than 320° C., and therefore, the binding between the fluoro-rubbers is undesirably cut off to thermally decompose the fluoro-rubber.

On the other hand, in the present embodiment, the temperature in the step (S1) can be decreased to about 180° C. to 220° C. at which the dehydrofluorination reaction sufficiently proceeds. Also in the present embodiment, the dehydrofluorination reaction is completed in the step (S1). Thus, as described later in practical examples, even if the temperature in the polyol crosslinking reaction is set to 325° C. to 345° C. in the step (S3) in accordance with the melting point of the fluororesin (B), the thermal decomposition of the fluoro-rubber (A) hardly occurs. Thus, even if a fluororesin having a melting point that is equal to or higher than 300° C. is used in the method of manufacturing the thermoplastic fluororesin composite of the present embodiment, the thermal decomposition of the fluoro-rubber can be suppressed.

However, in the polyol crosslinking reaction, if the crosslinking reaction proceeds without the kneading of the mixture of the fluoro-rubber (A), the fluororesin (B) and the compatibilizer (C), the crosslinking of the fluoro-rubber (A) proceeds in this mixture before the fluoro-rubber (A) is sufficiently dispersed, and the dispersion of each component may become nonuniform. Therefore, in order to perform the dynamic crosslinking, it is necessary to cause the crosslinking reaction to proceed after the mixture of the fluoro-rubber (A), the fluororesin (B) and the compatibilizer (C) is kneaded to some extent.

Thus, in the present embodiment, the step (S2) is provided between the step (S1) and the step (S3). In the step (S2), the fluoro-rubber (A) and the compatibilizer (C) with the double bonds formed are sufficiently kneaded with the fluororesin (B) in a state without the polyol crosslinker (D), and therefore, the dispersion of each component can be made uniform.

Also, as described above, in the study example 2, the dynamic crosslinking is performed in the step (a), and then, the second fluororesin (B″) is added to and kneaded with the crosslinked product in the step (b). In this case, if the mass ratio of the fluoro-rubber (A) with respect to the first fluororesin (B′) is high, the thermoplastic fluororesin composite in which the crosslinked fluoro-rubber (A) is the dispersion phase (island phase) while the first fluororesin (B′) and the second fluororesin (B″) are the continuous phase (sea phase) cannot be generated. As described above, a reason for this in the study example 2 may be in that the network of the crosslinked fluoro-rubber (A) is rigid so that the phase structure cannot be reversed since the fluororesin (B) is added and kneaded after the fluoro-rubber (A) is crosslinked.

On the other hand, in the present embodiment, when the fluoro-rubber (A) and the fluororesin (B) are kneaded in the step (S2), the fluoro-rubber (A) is not crosslinked yet. And, after the fluoro-rubber (A) and the fluororesin (B) are sufficiently kneaded in the step (S2), the dynamic crosslinking is performed in the step (S3). In this manner, it can be thought that the thermoplastic fluororesin composite in which the crosslinked fluoro-rubber (A) is the dispersion phase (island phase) while the fluororesin (B) is the continuous phase (sea phase) can be generated.

When the fluoro-rubber (A) is crosslinked by the polyol crosslinking, decomposition residual of the crosslinking accelerator (E) such as benzyl triphenyl phosphonium chloride possibly remains in the thermoplastic fluororesin composite that is an end product. This case has a problem of large reduction in a volume resistivity of the thermoplastic fluororesin composite. Regarding this point, in the present embodiment, after the crosslinking accelerator (E) is reacted in the step (S1), the temperature is increased to 300° C. or higher in accordance with the melting point of the fluororesin (B) in the step (S2). Thus, the decomposition residual of the crosslinking accelerator (E) is further thermally decomposed, and hardly remains in the thermoplastic fluororesin composite that is the end product. Thus, the thermoplastic fluororesin composite of the present embodiment can solve the above-described problem.

Also, the thermoplastic fluororesin composite of the present embodiment can be continuously used at 250° C. in spite of containing a large amount of the fluoro-rubber (A) having a heat-resistance life that is essentially low as 200° C. For example, it can be thought as follows. Even if the thermoplastic fluororesin composite is continuously used at 250° C. so that the crosslinked fluoro-rubber (A) thermally deteriorates and eventually disappears, the disappearing portion becomes a small gap since the crosslinked fluoro-rubber (A) is the dispersion phase and since the dispersion diameter of the crosslinked fluoro-rubber (A) is small, and thus, the thermoplastic fluororesin composite changes to small foam of the fluororesin (B) as a whole. Thus, it can be thought that the shape of the thermoplastic fluororesin composite is kept so that the mechanical property and the flexibility hardly deteriorate.

In this manner, in the method of manufacturing the thermoplastic fluororesin composite of the present embodiment, when the perfluoroalkoxy alkane is used as the fluororesin, the thermoplastic fluororesin composite that is excellent in the mechanical property and the heat resistance can be generated.

(2) Electric Wire

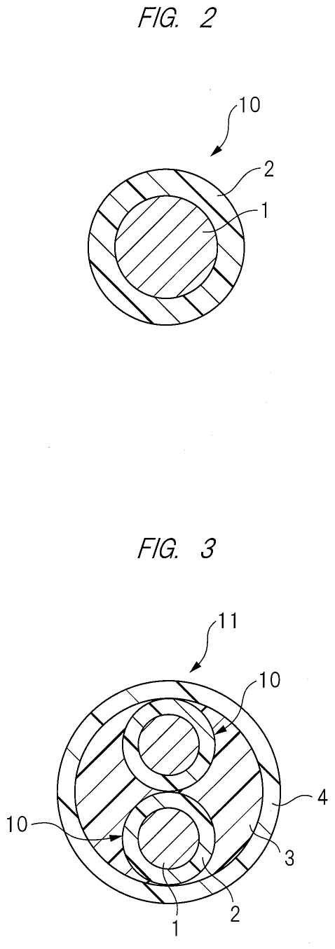

FIG. 2 is a horizontal cross-sectional view showing an electric wire (insulated electric wire) according to one embodiment of the present invention. As shown in FIG. 2, an electric wire 10 according to the present embodiment includes a conductor 1 and an insulating layer 2 which covers a periphery of the conductor 1. The insulating layer 2 is made of the above-described thermoplastic fluororesin composite.

As the conductor 1, not only a normally-used metal wire such as a copper wire or a copper alloy wire, but also an aluminum wire, a gold wire, a silver wire, etc., can be used. Also, as the conductor 1, a material formed by metal plating to a metal wire with a metal such as tin or nickel may be used. Furthermore, as the conductor 1, a stranded conductor formed by intertwining metal wires can also be used.

For example, the electric wire 10 of the present embodiment is manufactured as follows. First, a copper wire is prepared as the conductor 1. Then, by an extruder, the above-described thermoplastic fluororesin composite is extruded so as to cover the periphery of the conductor 1 to form the insulating layer 2 having a predetermined thickness. In this manner, the electric wire 10 of the present embodiment can be manufactured.

The thermoplastic fluororesin composite for use in the present embodiment is applicable to not only the electric wire fabricated in the practical examples but also electric wires having any intended use and size, and can be used for the insulating layer of each of electric wires for use in onboard wiring, vehicles, automobiles, wiring inside equipment, and electric power.

Particularly, as described above, the thermoplastic fluororesin composite configuring the insulating layer 2 of the electric wire 10 of the present embodiment has the favorable tensile property and flexibility, and has the advantage enabling the continuous use at 250° C. Thus, the electric wire 10 of the present embodiment can be used as a fluororesin-composite-covered electric wire that is excellent in the bendability and the heat resistance.

(3) Cable

FIG. 3 is a horizontal cross-sectional view showing a cable 11 according to one embodiment of the present invention. As shown in FIG. 3, the cable 11 according to the present embodiment includes a double-core stranded wire formed by intertwining two electric wires 10 described above stranded, a filler 3 provided in the periphery of the double-core stranded wire, and a sheath 4 provided in the periphery of the filler 3. The sheath 4 is made of the above-described thermoplastic fluororesin composite.

For example, the cable 11 of the present embodiment is manufactured as follows. First, two electric wires 10 are manufactured by the above-described method. Then, the periphery of the electric wires 10 is covered with the filler 3. Then, the above-described thermoplastic fluororesin composite is extruded so as to cover the filler 3 to form the sheath 4 having a predetermined thickness. In this manner, the cable 11 of the present embodiment can be manufactured.

As described above, the thermoplastic fluororesin composite configuring the sheath 4 of the cable 11 of the present embodiment has the favorable tensile property and flexibility, and has the advantage enabling the continuous use at 250° C. Thus, the cable 11 of the present embodiment can be used as a fluororesin cable that is excellent in the bendability and the heat resistance.

The cable 11 of the present embodiment has been described in the case with the double-core stranded wire formed by intertwining the two electric wires 10 as a core wire for the example. However, the core wire may be a single core (one wire) or a multi-core stranded wire other than the double-core stranded wire. Also, a multilayer sheath structure with another insulating layer (sheath) formed between the electric wires 10 and the sheath 4 can be also adopted.

Also, the cable 11 of the present embodiment has been described in the case with the usage of the above-described electric wire 10 for the example. However, the usage example is not limited to this, and an electric wire using a general-purpose material can be also used.

### PRACTICAL EXAMPLES

The present invention will be described in more details below on the basis of the practical examples. However, the present invention is not limited to these practical examples.

### Practical Examples 1 to 6 and Comparative Example 1

Practical examples 1 to 6 and a comparative example 1 will be described below. These practical examples and comparative example handle the thermoplastic fluororesin composite manufactured by the manufacturing method of the present embodiment.

### Configurations of Practical Examples 1 to 6 and Comparative Example 1

Materials used in the practical examples 1 to 6 and the comparative example 1 are as follows.

(A) Fluoro-rubber: DS246 (a hexafluoro propylene/vinylidene fluoride bipolymer, made in China, specific gravity of 1.86, Mooney viscosity of 75)

(B) Fluororesin:

(B1) F1540 (a copolymer of trifluoro (trifluoromethoxy) ethylene and tetrafuloroethylene, made by Solvay S.A., MFR (melt mass flow rate) of 8 to 18 g/10 min., melting point of 270° C.) (B2) M640 (a copolymer of trifluoro (trifluoromethoxy) ethylene, 1,1,1,2,2,3,3-heptafluoro-3-[(trifluoroethenyl) oxy]propane and tetrafluoroethylene, made by Solvay S.A., MFR of 10 to 17 g/10 min., melting point of 285° C.)

(B3) AP-210 (a copolymer of trifluoro (trifluoroethoxy) ethylene and tetrafluoroethylene, made by DAIKIN INDUSTRIES, LTD., MFR of 14 g/10 min., melting point of 305° C.)

(B4) P120X (a copolymer of trifluoro (trifluoroethoxy) ethylene and tetrafluoroethylene, made by Solvay S.A., MFR of 2.5 to 5 g/10 min., melting point of 313° C.)

(C) Compatibilizer: THV-500GZ (a tetrafluoroethylene/hexafluoropropylene/vinylidene fluoride terpolymer, made by 3M Company, MFR of 10 g/10 min., melting point of 165° C.)

(D) Polyol crosslinker: Curative 30 masterbatch (a mixture of 50% dihydroxy aromatic compound (polyol crosslinker) and 50% fluoro-rubber, made by DuPont de Nemours, Inc.)

(E) Crosslinking accelerator: Curative 20 masterbatch (a mixture of 33% benzyl triphenyl phosphonium chloride (crosslinking accelerator) and 67% fluoro-rubber, made by DuPont de Nemours, Inc.)

(F) Cross-linking accelerator aid (acid acceptor): Magnesium oxide (MgO)

Here, details of physical property values of F1540 (B1), M640 (B2), AP-210 (B3), and P120X (B4) each as the fluororesin (B) used in each practical example are summarized in Table 1.

TABLE 1

| Fluororesin (B) | F1540 (B1) | M640 (B2) | AP-210 (B3) | P120X (B4) |
|---|---|---|---|---|
| Melting point (° C.) | 265 to 275 | 280 to 290 | 300 to 310 | 310 to 316 |
| Specific gravity (ASTM D792) | 2.11 to 2.16 | 2.13 to 2.18 | 2.14 to 2.16 | 2.12 to 2.17 |
| Tensile Strength (MPa) (ASTM D638) | 25 | 21 | 25.5 to 30.4 * | 26 *** |
| Elongation (%) (ASTM D638) | 300 | 280 | 350 to 450 * | 300 *** |
| Hardness (Shore D) (ASTM D2240) | 55 to 60 | 55 to 60 | 60 to 70 | — |
| Tensile modulus of elasticity (MPa) (ASTM D638) | 400 to 500 | 500 to 600 | 500 to 600 ** | 500 to 600 *** |
| Continuous use temperature (° C.) (without load) | 225 | 250 | 260 | 300 |
| MRF (g/10 min.) | 8 to 18 | 10 to 17 | 10 to 17 | 2.5 to 5 |

* The test method is based on JIS K 6891.
** The test method is based on ASTM D895.
*** The test method is based on ASTM D1708.

In Table 2, details of a fluoro-rubber masterbatch 1 (MB1) and a fluoro-rubber masterbatch 101 (MB101) are summarized.

TABLE 2

| Fluoro-rubber masterbatch | | MB1 | MB101 |
|---|---|---|---|
| Fluoro-rubber (FKM) (A) | DS246 | 100 | 100 |
| Compatibilizer (C) | THV-500GZ (C1) | 8 | 8 |
| Crosslinking accelerator (E) | Curative #20 ** | 4 | — |
| Crosslinking accelerator aid(F) | MgO | 5 | 5 |

| | | |
|---|---|---|
| Total | 117 | 113 |
| Setting temperature (° C.) | 160 | 160 |
| Rotor rotation speed (rpm) | 35 | 35 |

** Containing 67% of FKM component (A)

As shown in Table 2, the fluoro-rubber masterbatch 1 was obtained by kneading the fluoro-rubber (A), the compatibilizer (C), the crosslinking accelerator (E), and the crosslinking accelerator aid (F) to form the double bonds in the fluoro-rubber (A) and the compatibilizer (C), and then, performing the pelletization. On the other hand, the fluoro-rubber masterbatch 101 was obtained by kneading the fluoro-rubber (A), the compatibilizer (C), and the crosslinking accelerator aid (F), and performing the pelletization. Since the fluoro-rubber masterbatch 101 does not contain the crosslinking accelerator (E), no double bond was formed in the fluoro-rubber (A) and the compatibilizer (C). As described later, in the practical examples 1 to 6 and the comparative example 1, the thermoplastic fluororesin composite was generated by fabricating pellets of the fluoro-rubber masterbatch 1 and the fluoro-rubber masterbatch 101 shown in Table 2, and then, dry-blending the fluororesin, etc.

In Table 3, a blend ratio of the respective materials is shown. In the practical examples 1 to 6 and the comparative example 1, such amounts of the materials as having a total volume of about 50 mL were used.

TABLE 3

| | | PRACTICAL EXAMPLE | | | |
|---|---|---|---|---|---|
| | | PRACTICAL | PRACTICAL | PRACTICAL | PRACTICAL |
| | | EXAMPLE 1 | EXAMPLE 2 | EXAMPLE 3 | EXAMPLE 4 |
| FLUORO-RUBBER | MB 1 | 117 | 117 | 117 | 117 |
| MASTERBATCH | MB 101 | | | | |
| FLUORORESIN (PFA) (B) | (B1) F1540 (MELTING POINT: 270° C.) | 40 | 35 | 80 | 25 |
| | (B2) M640 (MELTING POINT: 285° C.) | 40 | 85 | 30 | 25 |
| | (B3) AP-210 | | | 60 | 50 |
| | (MELTING POINT: 305° C.) | | | | |
| | (B4) P120X (MELTING POINT: 313° C.) | 80 | 70 | | |
| POLYOL CROSSLINKER (D) | CURATIVE #30* | 4 | 4 | 4 | 4 |
| TOTAL | | 281 | 261 | 241 | 221 |
| RATIO OF FKM (A) WITH RESPECT TO ALL COMPONENTS | | 36.6% | 38.3% | 41.5% | 45.2% |
| RATIO OF PFA (B) WITH RESPECT TO ALL COMPONENTS | | 56.9% | 53.6% | 49.8% | 45.2% |
| RATIO OF COMPATIBILIZER (C) | | 2.8% | 3.1% | 3.3% | 3.6% |
| WITH RESPECT TO ALL COMPONENTS | | | | | |
| RATIO OF FKM (A) WITH RESPECT TO FKM (A) + PFA (B) | | 38.5% | 41.7% | 45.5% | 50.0% |
| RATIO OF PFA (B) WITH RESPECT TO FKM (A) + PFA (B) | | 61.5% | 58.3% | 54.5% | 50.0% |
| RATIO OF COMPATIBILIER (C) | | 3.1% | 3.3% | 3.6% | 4.0% |
| WITH RESPECT TO PKM (A) + PFA (B) | | | | | |
| (1) APPERANCE | | ◯ | ◯ | ◯ | ◯ |
| (2) DRAW-DOWN CAPABILITY | | ◯ | ◯ | ◯ | ◯ |
| (3) THERMAL STABILITY | | ◯ | ◯ | ◯ | ◯ |
| (4) PHASE STRUCTURE | | SEA ISLAND | SEA ISLAND | SEA ISLAND | SEA ISLAND |
| (5) TENSILE PROPERTY | STORAGE ELASTIC MODULUS (Pa) | 8.0E+06 | 2.8E+08 | 1.9E+09 | 1.6E+06 |
| (UNTREATED) | TS (MPa) | 12.3 | 13.4 | 11.7 | 13.0 |
| | TE (%) | 380 | 400 | 390 | 410 |
| | 100% M (MPa) | 7.4 | 7.4 | 6.5 | 6.9 |
| (6) TENSILE PROPERTY | TS (MPa) | 12.5 | 13.3 | 9.9 | 3.8 |
| (AFTER HEATING) | TE (%) | 360 | 370 | 360 | 370 |
| | 100% M (MPa) | 9.7 | 8.9 | 6.9 | 6.3 |

| | | PRACTICAL EXAMPLE | | |
|---|---|---|---|---|
| | | PRACTICAL | PRACTICAL | COMPARATIVE |
| | | EXAMPLE 5 | EXAMPLE 6 | EXAMPLE 1 |
| FLUORO-RUBBER | MB 1 | 117 | 117 | |
| MASTERBATCH | MB 101 | | | 113 |
| FLUORORESIN (PFA) (B) | (B1) F1540 (MELTING POINT: 270° C.) | | | 30 |
| | (B2) M640 (MELTING POINT: 285° C.) | | | 30 |
| | (B3) AP-210 | 140 | | 60 |
| | (MELTING POINT: 305° C.) | | | |
| | (B4) P120X (MELTING POINT: 313° C.) | | 140 | |
| POLYOL CROSSLINKER (D) | CURATIVE #30* | 4 | 4 | 4 |
| TOTAL | | 261 | 261 | 237 |
| RATIO OF FKM (A) WITH RESPECT TO ALL COMPONENTS | | 38.3% | 38.3% | 42.2% |
| RATIO OF PFA (B) WITH RESPECT TO ALL COMPONENTS | | 53.6% | 53.6% | 50.6% |
| RATIO OF COMPATIBILIZER (C) | | 3.1% | 3.1% | 3.4% |
| WITH RESPECT TO ALL COMPONENTS | | | | |
| RATIO OF FKM (A) WITH RESPECT TO FKM (A) + PFA (B) | | 41.7% | 41.7% | 45.5% |
| RATIO OF PFA (B) WITH RESPECT TO FKM (A) + PFA (B) | | 58.3% | 58.3% | 54.5% |
| RATIO OF COMPATIBILIER (C) | | 3.3% | 3.3% | 3.6% |
| WITH RESPECT TO PKM (A) + PFA (B) | | | | |
| (1) APPERANCE | | ◯ | ◯ | X |
| (2) DRAW-DOWN CAPABILITY | | ◯ | ◯ | ~ |
| (3) THERMAL STABILITY | | ◯ | ◯ | ~ |
| (4) PHASE STRUCTURE | | SEA ISLAND | SEA ISLAND | ~ |
| (5) TENSILE PROPERTY | STORAGE ELASTIC MODULUS (Pa) | 2.9E+08 | 2.8E+08 | ~ |
| (UNTREATED) | TS (MPa) | 12.8 | 13.9 | ~ |
| | TE (%) | 380 | 390 | ~ |
| | 100% M (MPa) | 7.0 | 7.1 | ~ |
| (6) TENSILE PROPERTY | TS (MPa) | 15.1 | 10.4 | ~ |
| (AFTER HEATING) | TE (%) | 390 | 420 | ~ |
| | 100% M (MPa) | 9.4 | 7.8 | ~ |

*CONTAINING 50% OF FKM COMPONENT (A)

As shown in Table 3, the practical examples 1 to 6 are common with one another in that the fluoro-rubber masterbatch 1 is used. Thus, the blend amounts of the fluoro-rubber (A), the compatibilizer (C), the crosslinking accelerator (E), and the crosslinking accelerator aid (F) are equal to one another. On the other hand, the practical examples 1 to 6 are different from one another in that the fluororesin (B) with a different melting point is blended at a different ratio. Also, while the blend ratio of the fluororesin (B) of the comparative example 1 is equal to that of the practical example 3, the comparative example 1 is different from the practical example 3 in that the fluoro-rubber masterbatch 101 is used.

In the practical example 6, only P120X (melting point of 313° C.) (B4), which has the highest melting point among the fluororesins to be used, is used as the fluororesin (B). In the practical example 5, only AP-210 (melting point of 305° C.) (B3), which has the second highest melting point among the fluororesins to be used, is used as the fluororesin (B).

In the practical example 3 and the practical example 4, in addition to P120X (melting point of 313° C.) (B4), F1540 (melting point of 270° C.) (B1) and M640 (melting point of 285° C.) (B2), each of which has a melting point lower than that of P120X (B4), are blended. The practical example 1 and the practical example 2 are different from the practical example 3 and the practical example 4 in that not P120X (melting point of 313° C.) (B4) but AP-210 (melting point of 305° C.) (B3) is used. That is, in the practical example 1 and the practical example 2, in addition to AP-210 (melting point of 305° C.) (B3), F1540 (melting point of 270° C.) (B1) and M640 (melting point of 285° C.) (B2), each of which has a melting point lower than that of AP-210 (B3), are blended.

The practical example 2 has the ratio of the fluoro-rubber (A) with respect to the fluororesin (B) that is higher than that of the practical example 1. Similarly, the practical example 4 has the ratio of the fluoro-rubber (A) with respect to the fluororesin (B) that is higher than that of the practical example 3. If any type of the fluororesin (B) can be used, the practical example 4 has the highest ratio of the fluoro-rubber (A) with respect to the fluororesin (B), the practical example 3 is the next, the practical example 2, the practical example 5 and the practical example 6 are the third, fourth and fifth, and the practical example 1 has the lowest ratio of the fluoro-rubber (A) with respect to the fluororesin (B).

The practical example 1 to the practical example 6 have the same amount of the polyol crosslinker (D) as one another.

### Manufacturing Methods of Practical Examples 1 to 6

Samples of the practical examples 1 to 6 are fabricated by the following method. Each condition is an example.

(a) Masterbatch Fabricating Step (Corresponding to the Double Bond Forming Step (S1) of the Present Embodiment)

The fluoro-rubber (A), the compatibilizer (C), the crosslinking accelerator (E), and the crosslinking accelerator aid (acid acceptor) (F) were loaded into a 3 L pressure kneader set at 160° C. and kneaded at a rotor rotation speed of 35 rpm. Here, since a compound temperature increases to 200° C. due to self-heating, the rotor rotation speed was adjusted so as to keep the compound temperature of 200° C. at the time when the compound temperature reaches 200° C., and then, the kneading was performed for ten minutes. Here, the compound was showing a brown hue as the double bonds were being formed in the fluoro-rubber (A) and the compatibilizer (C) in the compound. Thus, on the basis of the hue of the compound, progress of the double bond forming reaction was checked.

Then, a product was taken out from the pressure kneader, and was rolled by an 8-inch roll set at 140° C. to fabricate a sheet having a thickness of 2 mm to 3 mm. After air-cooling, the fabricated sheet was cut by a pelletizer into 2 to 3 mm square to fabricate pellets of the fluoro-rubber masterbatch 1.

(b) Dry Blending Step (Corresponding to the Fluororesin Kneading Step (S2) of the Present Embodiment)

The pellets of the fluoro-rubber masterbatch 1 and the fluororesin (B) were dry-blended at a ratio shown in Table 3, were melt and kneaded by using a counter-rotating 20-mm twin-screw extruder made of hastelloy, were extruded into a strand shape, and then, were water-cooled.

In the twin-screw extruder, a ratio “L/D” between a screw diameter “D” and a screw length “L” was set to 25, and the number of rotations of the screw was set to 120 rpm. Also, in the practical examples 1 to 5, temperatures of four cylinders were set to 300° C., 320° C., 340° C., and 340° C. from a hopper side. In the practical example 6, the temperatures of four cylinders were set to 300° C., 330° C., 350° C., and 350° C. from the hopper side. This is because, in the practical example 6, only P120X (melting point of 313° C.) (B4), which has the highest melting point among those of the fluororesin to be used, is used as the fluororesin (B).

The extruded strand which was generated as described above was cut by the pelletizer, and was dried at 80° C. for 24 hours to fabricate pellets made of a non-crosslinked fluororesin composite.

(c) Crosslinking Step (Corresponding to the Dynamic Crosslinking Step (S3) of the Present Embodiment)

The pellets of the non-crosslinked fluororesin composite and the polyol crosslinker (D) were dry-blended at a ratio shown in Table 3, were melt and kneaded by using the counter-rotating 20-mm twin-screw extruder made of hastelloy, were extruded into a strand shape, and then, were water-cooled. Note that the conditions such as the screw and the cylinder temperatures of the twin-screw extruder were the same as those of the above-described dry blending step (b).

The extruded strand which was generated as described above was cut by the pelletizer, and was thermally dried at 230° C. for 2 hours to fabricate pellets made of a crosslinked fluororesin composite (thermoplastic fluororesin composite).

(d) Extruding Step

The pellets of the crosslinked fluororesin composite (thermoplastic fluororesin composite) were extruded at a shear rate of 20 sec⁻¹ by using a dice with a set temperature of 320° C., an outer diameter of 2.095 mmϕ, and a land of 8 mm in a Capilograph (produced by Toyo Seiki Co., Ltd.). A sample obtained here is referred to as “extruded capillary strand”.

### Manufacturing Method of Comparative Example 1

A sample of the comparative example 1 was fabricated by the following method. The comparative example 1 is different from the practical examples 1 to 6 in that the crosslinking accelerator (E) is added in not the masterbatch fabricating step (a) but the crosslinking step (c).

(a) Masterbatch Fabricating Step

The fluoro-rubber (A), the compatibilizer (C) and the crosslinking accelerator aid (acid acceptor) (F) were loaded into a 3 L pressure kneader set at 160° C. and were kneaded at the rotor rotation speed of 35 rpm. As different from the practical examples 1 to 6, the crosslinking accelerator (E) was not added. The kneading ended at the time when the compound temperature increased to 180° C. by self-heating.

Then, a product was taken out from the pressure kneader and was rolled by an 8-inch roll set at 140° C. to fabricate a sheet having a thickness of 2 mm to 3 mm. After air-cooling, the fabricated sheet was cut by the pelletizer into 2 to 3 mm square to fabricate pellets of the fluoro-rubber masterbatch 101.

(b) Dry Blending Step

The pellets of the fluoro-rubber masterbatch 101 and the fluororesin (B) were dry-blended at a ratio shown in Table 3, were melt and kneaded by using a counter-rotating 20-mm twin-screw extruder made of Hastelloy, were extruded into a strand shape, and then, were water-cooled.

Note that the ratio “L/D” between the screw diameter “D” and the screw length “L” was set to 25, and the number of rotations of the screw was set to 120 rpm. Also, the temperatures of four cylinders were set to 300° C., 320° C., 340° C., and 340° C. from a hopper side.

The extruded strand which was generated as described above was cut by the pelletizer, and was dried at 80° C. for 24 hours to fabricate pellets made of a non-crosslinked fluororesin composite without the double bond.

(c) Crosslinking Step

In order to cause the dehydrofluorination reaction, which is a previous stage of the crosslinking step, to proceed, the pellets of the non-crosslinked fluororesin composite without the double bonds and the crosslinking accelerator (E) were dry-blended, and were melt and kneaded by using the counter-rotating 20-mm twin-screw extruder made of hastelloy. Note that the conditions such as the screw and the cylinder temperatures of the twin-screw extruder were the same as those of the above-described dry blending step (b).

However, in an attempt to extrude the material after the melting and kneading, the material was severely decomposed and could not be formed into the strand shape.

### Evaluation Method of Practical Examples 1 to 6 and Comparative Example 1

(1) Appearance

The appearance of the extruded capillary strand sample was evaluated by visual inspection, etc. Specifically, as to a surface state, a sample having a sufficiently smooth surface was evaluated as (◯) while a sample having a significant rough surface was evaluated as (X). In this evaluation, the (◯) indicates “passed” and the (X) indicates “failure”.

(2) Draw-Down Capability

The extruded capillary strand sample was further drawn down so that its outer diameter was about 0.2 mmϕ, and the outer appearance and the outer-diameter stability were examined. A sample which passed in both the outer appearance and the outer-diameter stability was evaluated as (◯) (passed), and a sample which failed in either the outer appearance or the outer-diameter stability was evaluated as (X) (failure).

(3) Thermal Stability

The extruded capillary strand sample was retained in a cylinder of a capillary in a melt indexer for 5 minutes, and then, was drawn down so that the outer diameter is about 0.2 mmϕ, and the outer appearance and outer-diameter stability were examined. A sample which passed in both the outer appearance and the outer-diameter stability was evaluated as (◯) (passed), and a sample which failed in either the outer appearance or the outer-diameter stability was evaluated as (X) (failure).

(4) Phase Structure

The extruded capillary strand sample cut by a razor into round slices each having a thickness of about 1 mm was observed by a scanning electron microscope (SEM) under conditions with an acceleration voltage of 15 kV, a degree of vacuum of 30 Pa, and a magnification of 1000 times.

(5) Tensile Property (Untreated)

To the extruded capillary strand sample before the drawing down, a storage elastic modulus was measured by a viscoelastic analyzer (Model: DVA-200) produced by ITK Co., Ltd. (IT keisoku seigyo limited company), under conditions with a grip width of 20 mm, a frequency of 10 Hz, a distortion of 0.5%, and a measurement temperature of 20° C.

Also, in the extruded capillary strand sample, tension, tensile strength (maximum stress) (denoted as “TS” in Table 3), a total elongation (breaking elongation) (denoted as “TE” in Table 3), and 100% modulus (denoted as “100% M” in Table 3) were measured by using a commercially-available tensile tester at a tension speed of 200 mm/min. Here, the tensile strength is a stress corresponding to the maximum applied force during the test. The total elongation is a value indicating permanent elongation after the breaking to be expressed as a percentage with respect to an original length. The 100% modulus is a stress caused when 100% elongation occurs in a test piece.

(6) Tensile Property (after Heating at 280° C. for 30 Days): Heat Resistance

The extruded capillary strand sample was heated at 280° C. for 30 days, and then, was elongated by using the commercially-available tensile tester at a tension speed of 200 mm/min., and the tension, the tensile strength (TS), the total elongation (TE), and the 100% modulus (100% M) were measured.

### Evaluation Results of Practical Examples 1 to 6 and Comparative Example 1

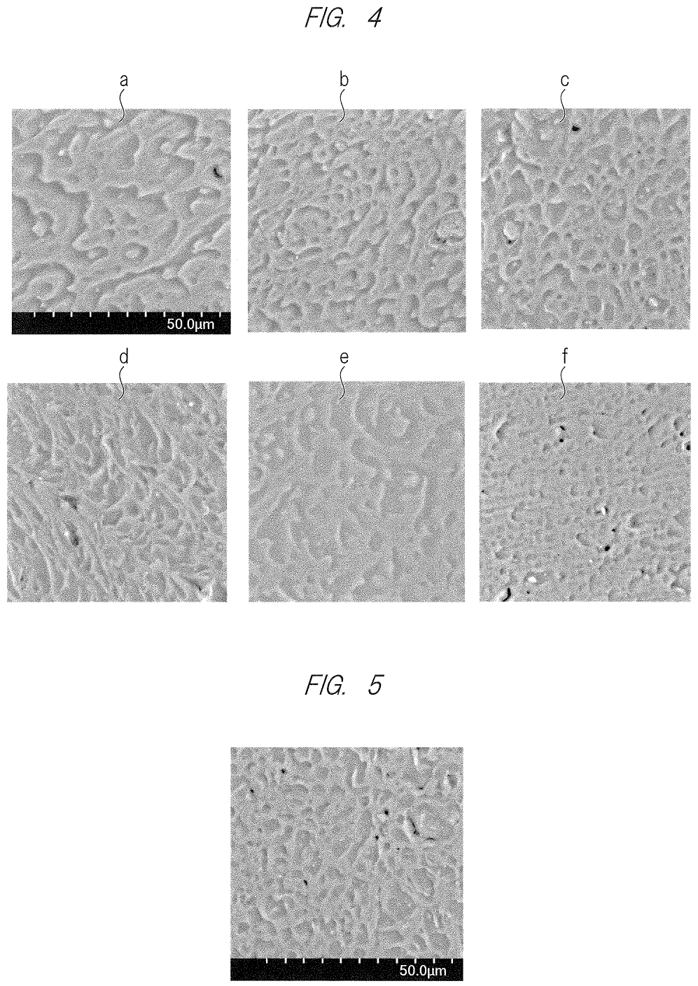

The measurement results are summarized in Table 3 and FIG. 4. FIG. 4 is scanning electron micrographs of horizontal cross sections of the extruded capillary strand samples of the practical examples 1 to 6. In FIG. 4, “a” corresponds to the practical example 1, “b” corresponds to the practical example 2, “c” corresponds to the practical example 3, “d” corresponds to the practical example 4, “e” corresponds to the practical example 5, and “f” corresponds to the practical example 6. In Table 3, the fluoro-rubber is denoted as “FKM”, and the fluororesin is denoted as “PFA”.

As shown in Table 3, in the practical examples 1 to 6, all (1) the appearance, (2) the draw-down capability, (3) the thermal stability, (4) the phase structure, (5) the tensile property (untreated), and (6) the tensile property (after heating) were favorable.

As shown in FIG. 4, in the practical examples 1 to 6 (regions “a” to “f”), (4) the phase structure of the extruded capillary strand sample was a sea-island structure. That is, the fluororesin (B) was the continuous phase while the crosslinked fluoro-rubber (A) was the dispersion phase. Also, in the practical example 3 to the practical example 8 (regions “c” to “h” in FIG. 3), the dispersion diameter of the crosslinked fluoro-rubber (A) was small to be about 10 μm.

On the other hand, in the comparative example 1, as described above, the severe decomposition was caused in the crosslinking step (c), and the sample could not be formed into the strand shape. As a result, the sample failed in (1) the appearance, and the other items could not be evaluated.

### Practical Example 7

A practical example 7 will be described below. This practical example 7 corresponds to the electric wire 10 shown in FIG. 2.

### Configuration of Practical Example 7

As the conductor 1 shown in FIG. 2, a nickel-plated stranded conductor having a cross sectional area of 2 mm² was used. Also, as the insulating layer 2, as shown in Table 4, a thermoplastic fluororesin composite having the same composition as that of the practical example 3 (see Table 3) was used.

### Manufacturing Method of Practical Example 7

A sample of the seventh example was fabricated by the following method. Each condition is merely an example.

The crosslinked fluoro-rubber masterbatch 1 was crushed into 1 mm square or smaller. The pellets of M620 (melting point of 285° C.) (B4) were added as the fluororesin (B), and these materials were dry blended. Next, a nickel-plated stranded conductor was inserted into a dice of a 20-mm single-screw extruder. Then, the dry-blended mixed pellets were loaded from a hopper of the 20-mm single-screw extruder, a thermoplastic fluororesin composite was extruded into a tube shape and was drawn down as being evacuated to vacuum so as to form an insulating layer having a thickness of 0.3 mm on the periphery of the nickel-plated stranded conductor, so that the electric wire was fabricated.

Note that the ratio “L/D” between the screw diameter “D” and the screw length “L” was set to 25. The temperatures of four cylinders were set to 200° C., 300° C., 320° C., and 320° C. from the hopper side, and a temperature of a head was set to 320° C. The number of rotations of the screw was set to 20 rpm. A dice was set to have “10 mmϕ× land of 5 mm”, and a nipple was set to have “7 mmϕϕland of 10 mm”.

### Evaluation Method of Practical Example 7

An evaluation method of the practical example 7 is the same as the evaluation methods of the practical examples 1 to 6 and the comparative example 1, and is thus not described herein. However, evaluation items were set to (1) the appearance, (2) the phase structure, (3) the tensile property (untreated), and (4) the tensile property (after heating at 280° C. for 30 days): heat resistance. These evaluation items were measured after the fabricated electric wire was pulled out from the conductor to be in a sample state only with the insulating layer.

### Evaluation Results of Practical Example 7

The measurement results are summarized in Table 4 and FIG. 5. FIG. 5 is a scanning electron micrograph of a horizontal cross section of the extruded capillary strand sample of the practical example 7. In Table 4, the fluoro-rubber is denoted as “FKM”, and the fluororesin is denoted as “PFA”.

TABLE 4

| | | PRACTICAL |
|---|---|---|
| PRACTICAL EXAMPLE | | EXAMPLE7 |
| FLUORO-RUBBER MASTERBATCH | MB1 | 117 |
| FLUORORESIN (PFA) (B) | (B1)F1540 (MELTING POINT: 270° C.) | 30 |
| | (B2)M640 (MELTING POINT: 285° C.) | 30 |
| | (B3)AP-210 (MELTING POINT: 305° C.) | 60 |
| POLYOL CROSSLINKER (D) | CURATIVE #30* | 4 |
| TOTAL | | 241 |
| RATIO OF FKM (A) WITH RESPECT TO ALL COMPONENTS | | 41.5% |
| RATIO OF PFA (B) WITH RESPECT TO ALL COMPONENTS | | 49.8% |
| RATIO OF COMPATIBILIZER (C) WITH RESPECT TO ALL COMPONENTS | | 3.3% |
| RATIO OF FKM (A) WITH RESPECT TO FKM (A) + P FA (B) | | 45.5% |
| RATIO OF PFA (B) WITH RESPECT TO FKM (A) + PFA (B) | | 54.5% |
| RATIO OF COMPATIBILIZER (C) WITH RESPECT TO FKM (A) + PFA (B) | | 3.6% |
| (1) APPEARANCE | | ◯ |
| (2) PHASE STRUCTURE | | SEA-ISLAND |
| (3) TENSILE PROPERTY | STORAGE ELASTIC MODULUS (Pa) | 1.9E+08 |
| (UNTREATED) | TS(MPa) | 11.6 |
| | TE(%) | 400 |
| | 100% M(MPa) | 6.4 |
| (4) TENSILE PROPERTY | TS(MPa) | 10.7 |
| (AFTER HEATING) | TE(%) | 400 |
| | 100% M(MPa) | 7.1 |

As shown in Table 4, in the practical example 7, all (1) the appearance, (3) the tensile property (untreated), and (4) the tensile property (after heating) were favorable. Also as shown in FIG. 5, in the practical example 7, (2) the phase structure was a sea-island structure. That is, the fluororesin (B) was the continuous phase while the crosslinked fluoro-rubber (A) was the dispersion phase.

### SUMMARY OF PRACTICAL EXAMPLES

As shown in the practical examples 1 to 7, according to the method of manufacturing the thermoplastic fluororesin composite of the present embodiment, even if a fluororesin having a melting point that is equal to or higher than 300° C. is used, thermal decomposition of the fluoro-rubber hardly occurs, and a thermoplastic fluororesin composite having the excellent mechanical property and heat resistance can be generated. Particularly, as shown in the practical example 6, even if only a fluororesin having a melting point of 313° C. is used and the temperatures of the cylinders of the twin-screw extruder are set to 340° C. at maximum, the thermal decomposition of the fluoro-rubber hardly occurs.

Also, as shown in the practical examples 1 to 6, according to the present embodiment, regardless of the type and the blend ratio of the fluororesin, the thermoplastic fluororesin composite having the excellent mechanical property can be generated. Particularly, as shown in the practical example 4, even if the fluoro-rubber (A) and the fluororesin (B) are combined in equivalent, the thermoplastic fluororesin composite in which the crosslinked fluoro-rubber (A) is the disperse phase (island phase) while the fluororesin (B) is the continuous phase (sea phase) can be generated.

The present invention is not limited to the embodiments and the practical examples described above, and various modifications can be made within the scope of the present invention.

What is claimed is:

1. A method of manufacturing a thermoplastic fluororesin composite comprising the steps of:
(a) kneading a mixture containing a fluoro-rubber, a compatibilizer and a crosslinking accelerator to form a double bond in the fluoro-rubber by a dehydrofluorination reaction;
(b) kneading a first product generated in the step (a) and a fluororesin; and
(c) kneading a second product generated in the step (b) and a polyol crosslinker to dynamically crosslink the fluoro-rubber in the second product.

2. The method of manufacturing the thermoplastic fluororesin composite according to claim 1,
wherein the fluororesin is made of perfluoroalkoxy alkane.

3. The method of manufacturing the thermoplastic fluororesin composite according to claim 1,
wherein, in the step (a), a double bond is also formed in the compatibilizer by the dehydrofluorination reaction, and,
in the step (c), the compatibilizer in the second product is also dynamically crosslinked.

4. The method of manufacturing the thermoplastic fluororesin composite according to claim 1,
wherein the mixture further contains an acid acceptor.

5. The method of manufacturing the thermoplastic fluororesin composite according to claim 1,
wherein the compatibilizer is a tetrafluoroethylene/hexafluoropropylene/vinylidene fluoride terpolymer.

6. A method of manufacturing an electric wire comprising the steps of:
(a) kneading a mixture containing a fluoro-rubber, a compatibilizer and a crosslinking accelerator to form a double bond in the fluoro-rubber by a dehydrofluorination reaction;
(b) kneading a first product generated in the step (a) and a fluororesin;
(c) kneading a second product generated in the step (b) and a polyol crosslinker to dynamically crosslink the fluoro-rubber in the second product; and
(d) extruding a thermoplastic fluororesin composite generated in the step (c) so as to cover a conductor therearound to form an insulating layer.

7. A method of manufacturing a cable comprising the steps of:
(a) kneading a mixture containing a fluoro-rubber, a compatibilizer and a crosslinking accelerator to form a double bond in the fluoro-rubber by a dehydrofluorination reaction;
(b) kneading a first product generated in the step (a) and a fluororesin;
(c) kneading a second product generated in the step (b) and a polyol crosslinker to dynamically crosslink the fluoro-rubber in the second product; and
(d) covering an electric wire therearound with a filler, and then, extruding a thermoplastic fluororesin composite generated in the step (c) so as to cover the filler to form a sheath.
